(19) United States
(12) Patent Application Publication
(10) Pub. No.: US 2025/0285247 A1
(43) Pub. Date: Sep. 11, 2025

(54) LOW POWER HIGH DYNAMIC RANGE TECHNIQUE

(71) Applicant: QUALCOMM Incorporated, San Diego, CA (US)

(72) Inventor: Nyeongkyu Kwon, San Diego, CA (US)

(21) Appl. No.: 18/601,643

(22) Filed: Mar. 11, 2024

(51) Int. Cl. G06T 5/92; G06T 5/50; H04N 25/589

(52) U.S. Cl. CPC G06T 5/92; G06T 5/50; H04N 25/589; G06T 2207/10144; G06T 2207/20208; G06T 2207/20224

(57) ABSTRACT

A computing device for image processing includes: a memory; and one or more processors implemented in circuitry, coupled to the memory, and configured to: while operating in a low power high dynamic range (HDR) mode: receive a first image having a first exposure time and a second image having a second exposure time; generate at least one reduced image from the first image or the second image; and generate an HDR image by selectively combining information from at least two of the first image, the second image, and the reduced image.

### TECHNICAL FIELD

This disclosure relates to image processing.

### BACKGROUND

A digital camera includes an image sensor that captures image frames. A low power High Dynamic Range (HDR) mode reduces the resolution of the captured image, to save processing power or memory. Images captured with a short exposure time typically capture less detail in highlights compared to images captured with longer exposure times.

### SUMMARY

In general, this disclosure describes techniques for low power modes for HDR image processing which can better reduce data rate with minimal reduction in image quality. An Image Signal Processor (ISP) handles image data from a camera sensor. In multi-exposure photography, the camera captures multiple images of the same scene with varying exposure times (e.g., one short and one long). Instead of processing each entire image (frame) from short and long exposures separately, the ISP may perform multi-context processing per image line. In other words, the ISP may process each line of the image data simultaneously from both the short and long exposure images. The ISP may essentially “switch context” between the two exposures for each line, combining information from both exposures to create the final image. Multi-partitioned ISP pipeline architecture divides the overall image processing tasks into multiple stages, each potentially handled by dedicated hardware or software. The multi-partitioned ISP pipeline architecture may allow for more efficient processing and flexibility. Inline ISP block is the initial stage in the pipeline. The inline ISP is directly “inline” with the data flow from the camera sensor. The inline ISP block may perform critical, time-sensitive processing tasks that typically happen right after capturing the image data. The inline ISP block typically converts the raw data from the camera sensor into a format usable by later stages in the pipeline. Such conversion might involve tasks like analog-to-digital conversion (ADC) and initial noise reduction. Following the inline ISP, the image data enters the offline ISP processing stages. The offline ISP processing stages may be implemented in hardware or software and may perform more complex, non-real-time processing tasks.

In multi-context mode, an inline ISP block is configured to output only a long exposure image and a reduced image. In one example, the reduced image may be delta (D) image generated by subtracting the long exposure image from a short exposure image. In another example, the reduced image may be one or more masked images of at least one of the short exposure image and/or the long exposure image.

The term “operating in low power HDR mode,” as used herein, refers to techniques used to capture and process HDR images while minimizing power consumption. Such low-power modes may be important for battery-powered devices such as, but not limited to, Advanced driver-assistance systems (ADAS) and infotainment features of a vehicle, smartphones and drones.

In accordance with aspects of this disclosure, the inline ISP block may reduce the amount of data in and/or the size of a short exposure image, potentially reducing redundancy. Adding ERC (Exposure Range Correction) gain before subtraction may enhance the high-brightness details in the D (delta) image. Adding ERC gain may aid compression by focusing on encoding the critical details more efficiently.

In accordance with aspects of this disclosure, another alternative low power mode may utilize a mask to “screen out” pixels that are less important for HDR blending. Such masking may reduce the amount of data processed and may save power. The mask may be generated based on several factors, such as, but not limited to, motion and highlight saturation. In short anchor mode, inline ISP block may identify motion areas from the short exposure image, as they typically capture details like moving objects better due to faster shutter speeds. Since the long exposure image captures a longer period of light, the long exposure image might contain motion blur in the corresponding areas identified as motion in the short exposure. Therefore, processing the long exposure pixels in the identified areas would be redundant and may be masked. Conversely, highlight saturation (areas with very bright pixels) is usually better captured in the long exposure image, as the long exposure image allows more light to reach the sensor. During HDR blending, such saturated pixels from the long exposure may replace the corresponding pixels from the short exposure to preserve details in bright areas. Hence, processing highlight saturation pixels from the short exposure image in the inline ISP block would be redundant, as they will be replaced later. Such pixels may be masked as well.

In one example, the generated mask may be applied to both short and long exposure images. Such application may reduce data for both images, potentially achieving more significant power savings. In another example, the generated mask may be applied to only short or long exposure images. Such application might offer flexibility based on specific image characteristics and power needs.

In some aspects, the techniques described herein relate to a computing device for image processing, the computing device including: a memory; and one or more processors implemented in circuitry, coupled to the memory, and configured to: while operating in a low power high dynamic range (HDR) mode: receive a first image having a first exposure time and a second image having a second exposure time; generate at least one reduced image from the first image or the second image; and generate an HDR image by selectively combining information from at least two of the first image, the second image, and the reduced image.

In another example, a method includes while operating in a low power high dynamic range (HDR) mode: receiving a first image having a first exposure time and a second image having a second exposure time, wherein the first exposure time is longer than the second exposure time; generating at least one reduced image from the first image or the second image; and generating an HDR image by selectively combining information from at least two of the first image, the second image and the at least one reduced image.

In yet another example, a computer-readable medium includes instructions that, when applied by processing circuitry, cause the processing circuitry to: while operating in a low power high dynamic range (HDR) mode: receive a first image having a first exposure time and a second image having a second exposure time; generate at least one reduced image from the first image or the second image; and generate an HDR image by selectively combining information from at least two of the first image, the second image, and the reduced image.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram of a device configured to perform one or more of the example techniques described in this disclosure.

FIG. 2 is a conceptual diagram illustrating image processing pipeline involving HDR image generation using first low power HDR mode according to the techniques of this disclosure.

FIG. 3 is a conceptual diagram illustrating example techniques for performing an alternative low power HDR mode according to the techniques of this disclosure.

FIG. 4 is a conceptual diagram illustrating image processing pipeline involving HDR image generation using the second low power HDR mode shown in FIG. 3 according to the techniques of this disclosure.

FIG. 5 is a conceptual diagram illustrating example techniques for performing mask threshold control in the low power HDR mode according to the techniques of this disclosure.

FIG. 6 is a conceptual diagram illustrating example techniques for performing mask threshold control for a composition mask in the low power HDR mode according to the techniques of this disclosure.

FIG. 7 is a conceptual diagram illustrating example techniques for performing mask threshold control for a blending mask in the low power HDR mode according to the techniques of this disclosure.

FIG. 8 is a flowchart showing an example method of operation according to the techniques of this disclosure.

### DETAILED DESCRIPTION

In many applications, higher resolutions require more data to process for HDR, increasing power consumption. Reducing image resolution (downscaling) before HDR processing may significantly decrease power usage. Techniques like binning or subsampling may achieve the decreased power usage. Furthermore, HDR processing may be focused on specific areas of interest within the image, reducing overall workload.

In general, this disclosure describes techniques for alternative low power HDR modes which may control a data reduction rate in tradeoff with image quality. Current low power HDR mode that uses downscaling for short exposure images has raised image quality concerns, as details may be lost in downscaled short exposure images. The term “exposure” in photography refers to the amount of light that reaches the image sensor and determines the brightness of the final image. Both long exposure and short exposure images have their own distinctive characteristics and are used for different purposes. A long exposure image is an image that is captured with a slow shutter speed, which may range from several milliseconds to even seconds. As the shutter remains open for longer, more light accumulates on the sensor, resulting in a brighter image. However, scenes often have areas with vastly different brightness levels. During a long exposure, both the dark and bright areas are exposed for the same duration. The increased light exposure brings out subtle details in shadows and dimly lit areas that would be underexposed in a regular photo. Conversely, areas already bright in the scene receive even more light, resulting in “blown highlights” or “overexposure,” where details are lost, and the area appears completely white. In contrast, short exposure images utilize a fast shutter speed, typically fractions of a second or less. Such an approach allows only a limited amount of light to reach the image sensor, creating a darker image. In scenes with bright light, short exposure prevents overexposure, where highlights appear completely white and lose detail. The sensor captures light for a shorter duration, ensuring the brighter areas remain within the tonal range and retain detail. Short exposure minimizes motion blur, the smearing or blurring of moving objects in an image. By keeping the shutter open for a brief period, the camera captures the object's position at a specific point in time, minimizing the blurring effect caused by movement during the exposure time. On the other hand, long exposure, while advantageous for capturing details in low-light situations, can lead to ghosting when there's movement in the scene. During a long exposure, the shutter stays open for a longer duration, capturing light over a longer period. If an object moves within the scene while the shutter is open, the camera captures its position at multiple points within that timeframe. This results in a blurring or smearing effect in the final image, creating ghost-like trails or outlines where the object moved, hence the term “ghosting.” HDR technique captures multiple exposures at different levels and merges them into a single image with improved dynamic range, encompassing both bright and dark areas without overexposure or underexposure.

Downscaling short exposure image means reducing the resolution of an image captured with a short exposure time. While short exposures might have less noise, they also capture fewer detail in dark areas of the image compared to longer exposures. Downscaling may further amplify this loss of detail. Due to the combination of short exposure and downscaling, some low power HDR modes might be losing information in the brightest areas of the image, leading to noticeable artifacts or a reduction in image quality.

In view of these drawbacks, this disclosure describes alternative low power HDR modes which move away from a fixed downscaling approach. Instead of the fixed downscaling, the disclosed techniques use a dynamic way to reduce data based on the specific image content and desired level of image quality. While achieving better image quality, the disclosed techniques reduce data compared to using both short and long exposure images without compression.

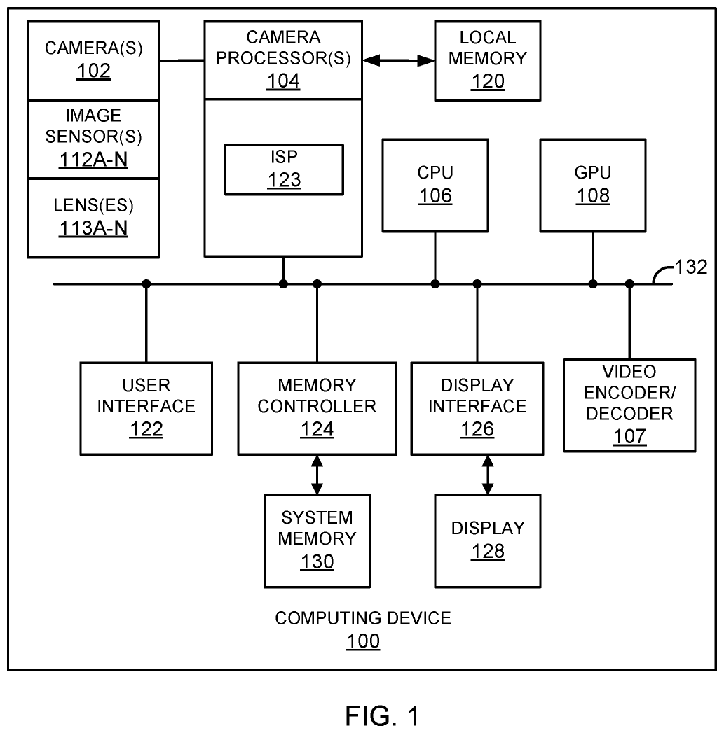

FIG. 1 is a block diagram of a computing device 100 configured to perform one or more of the example techniques described in this disclosure. Examples of computing device 100 include processing systems in an automobile (e.g., an advance driver assistance system (ADAS)), processing systems in a robotics application, augmented reality (AR) headsets, virtual reality (VR) headsets, stand-alone digital cameras or digital video camcorders, camera-equipped wireless communication device handsets, such as mobile telephones having one or more cameras, cellular or satellite radio telephones, camera-equipped personal digital assistants (PDAs), computing panels or tablets, gaming devices, computer devices that include cameras, such as so-called “web-cams,” or any device with digital imaging or video capabilities.

As illustrated in the example of FIG. 1, computing device 100 includes camera(s) 102 (e.g., having a lens, a filter, and an image sensor), camera processor 104 and local memory 120 of camera processor 104, a central processing unit (CPU) 106, a video encoder/decoder 107, a graphical processing unit (GPU) 108, user interface 122, memory controller 124 that provides access to system memory 130, and display interface 126 that outputs signals that cause graphical data to be displayed on display 128. Although the example of FIG. 1 illustrates computing device 100 including one camera 102, in some examples, computing device 100 may include a plurality of cameras 102, such as for omnidirectional image or video capture. Also, although computing device 100 is illustrated as including one camera processor 104, in some examples, there may be a plurality of camera processors (e.g., one for each of cameras 102) or one camera processor for each of one or more cameras 102.

As illustrated in the example of FIG. 1, computing device 100 includes one or more image sensor(s) 112A-N. Image sensor(s) 112A-N may be referred to in some instances herein simply as “sensor 112,” while in other instances may be referred to as a plurality of “sensors 112” where appropriate. Sensors 112 may be any type of image sensor, including sensors that include a Bayer filter, or HDR interlaced sensors, such as a Quad-Bayer sensor or a Quad-Bayer color filter array (QCFA) sensor.

Computing device 100 further includes one or more lens(es) 113A-N. Similarly, lens(es) 113A-N may be referred to in some instances herein simply as “lens 113,” while in other instances may be referred to as a plurality of “lenses 113” where appropriate. In some examples, sensor(s) 112 represent one or more image sensors 112 that may each include processing circuitry, an array of pixel sensors (e.g., pixels) for capturing representations of light, memory, such as buffer memory or on-chip sensor memory, etc. In some examples each of image sensors 112 may be coupled with a different type of lens 113, each lens and image sensor combination having different apertures and/or fields-of-view. Example lenses may include a telephoto lens, a wide-angle lens, an ultra-wide angle lens, or other lens types.

As shown in FIG. 1, camera processor(s) 104 may include and/or be configured to execute an image signal processor (ISP) 123. That is, ISP 123 may be software executed by camera processor(s) 104, may be firmware executed by camera processor(s) 104, or may be dedicated hardware within camera processor(s) 104.

Also, although the various components are illustrated as separate components, in some examples the components may be combined to form a system on chip (SoC). As an example, camera processor 104, CPU 106, GPU 108, and display interface 126 may be formed on a common integrated circuit (IC) chip. In some examples, one or more of camera processor 104, CPU 106, GPU 108, and display interface 126 may be in separate IC chips. Additional examples of components that may be configured to perform the example techniques include a digital signal processor (DSP). Various other permutations and combinations are possible, and the techniques should not be considered limited to the example illustrated in FIG. 1.

Various other permutations and combinations are possible, and the techniques of this disclosure should not be considered limited to the example illustrated in FIG. 1. In an example, CPU 106 may include camera processor(s) 104 such that one or more of camera processor(s) 104 are part of CPU 106. In such examples, CPU 106 may be configured to perform one or more of the various techniques otherwise ascribed herein to camera processor(s) 104. For purposes of this disclosure, camera processor(s) 104 will be described herein as being separate and distinct from CPU 106, although this may not always be the case.

The various components illustrated in FIG. 1 (whether formed on one device or different devices) may be formed as at least one of fixed-function or programmable circuitry such as in one or more microprocessors, application specific integrated circuits (ASICs), field programmable gate arrays (FPGAs), digital signal processors (DSPs), or other equivalent integrated or discrete logic circuitry. Examples of local memory 120 and system memory 130 include one or more volatile or non-volatile memories or storage devices, such as random access memory (RAM), static RAM (SRAM), dynamic RAM (DRAM), erasable programmable ROM (EPROM), electrically erasable programmable ROM (EEPROM), flash memory, a magnetic data media or an optical storage media.

The various units illustrated in FIG. 1 communicate with each other using bus 132. Bus 132 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced extensible Interface (AXI) bus) or another type of bus or device interconnect. The specific configuration of buses and communication interfaces between the different components shown in FIG. 1 is merely exemplary, and other configurations of camera devices and/or other image processing systems with the same or different components may be used to implement the techniques of this disclosure.

Camera processor 104 is configured to receive image frames from camera 102 and process the image frames to generate output frames for display. CPU 106, GPU 108, camera processor 104, or some other circuitry may be configured to process the output frame that includes image content generated by camera processor 104 into images for display on display 128. In some examples, GPU 108 may be further configured to render graphics content on display 128.

In some examples, camera processor 104 may be configured as an image processing pipeline. For instance, camera processor 104 may include a camera interface that interfaces between camera 102 and camera processor 104. Camera processor 104 may include additional circuitry to process the image content. Camera processor 104 outputs the resulting frames with image content (e.g., pixel values for each of the image pixels) to system memory 130 via memory controller 124.

CPU 106 may comprise a general-purpose or a special-purpose processor that controls operation of processing device 100. A user may provide input to processing device 100 to cause CPU 106 to execute one or more software applications. The software applications that execute on CPU 106 may include, for example, a media player application, a video game application, a graphical user interface application or another program. The user may provide input to computing device 100 via one or more input devices (not shown) such as a keyboard, a mouse, a microphone, a touch pad or another input device that is coupled to computing device 100 via user interface 122.

Memory controller 124 facilitates the transfer of data going into and out of system memory 130. For example, memory controller 124 may receive memory read and write commands, and service such commands with respect to system memory 130 in order to provide memory services for the components in computing device 100. Memory controller 124 is communicatively coupled to system memory 130. Although memory controller 124 is illustrated in the example of computing device 100 of FIG. 1 as being a processing circuit that is separate from both CPU 106 and system memory 130, in other examples, some or all of the functionality of memory controller 124 may be implemented on one or both of CPU 106 and system memory 130.

System memory 130 may store program modules and/or instructions and/or data that are accessible by camera processor 104, CPU 106, and GPU 108. For example, system memory 130 may store user applications, resulting frames from camera processor 104, etc. System memory 130 may additionally store information for use by and/or generated by other components of computing device 100. For example, system memory 130 may act as a device memory for camera processor 104.

In some examples, camera processor(s) 104 are configured to receive image frames (e.g., pixel data) from image sensor(s) 112 and process the image frames to generate image and/or video content. For example, image sensor(s) 112 may be configured to capture individual frames, HDR frames, frame bursts, frame sequences for generating video content, photo stills captured while recording video, preview frames, or motion photos from before and/or after capture of a still photograph. CPU 106, GPU 108, camera processor(s) 104, or some other circuitry may be configured to process the image and/or video content captured by sensor(s) 112 into images or video for display on display 128. Image frames may generally refer to frames of data for a still image or frames of video data or combinations thereof, such as with motion photos. Camera processor(s) 104 may receive from sensor(s) 112 pixel data of the image frames in any format. For example, the pixel data may include different color formats, such as RGB, YCbCr, YUV, etc. In any case, camera processor(s) 104 may receive, from image sensor(s) 112, a plurality of frames of image data.

In an example of the disclosure, camera processor(s) 104 may cause a particular image sensor of image sensors 112 to capture one or more images in an HDR mode. In some examples, camera processor(s) 104 and/or camera(s) 102 may be configured to capture and generate an HDR image according to one of a plurality of HDR capture techniques.

In one example, camera processor(s) 104 may cause an image sensor 112 to capture a plurality of images (e.g., two) at different exposure settings (e.g., a long exposure, and a short exposure). ISP 123 may receive the plurality of images and may generate at least one reduced image from the plurality of images. In one example, the reduced image may be a delta image. The delta image may be generated by subtracting the long exposure image from a short exposure image. Furthermore, ISP 123 may generate an HDR image by selectively combining information from at least two of the long exposure image, short exposure image and/or reduced image, as described below. In accordance with aspects of this disclosure, another alternative low power mode may utilize a mask to “screen out” pixels that are less important for HDR blending. Such masking may reduce the amount of data processed and may save power. The mask may be generated based on several factors, such as, but not limited to, motion and highlight saturation.

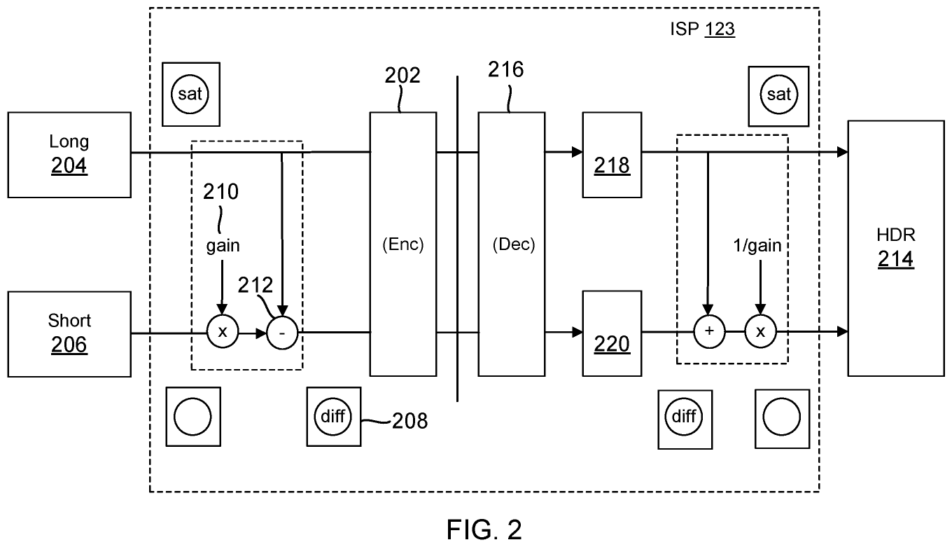

Additional details concerning the operation of ISP 123 in a low power mode are described in more detail below with reference to FIGS. 2-8.

One example software application is a camera application. CPU 106 executes the camera application, and in response, the camera application causes CPU 106 to generate content that display 128 outputs. The camera application may also cause CPU 106 to instruct camera processor(s) 104 to process the images output by sensor 112 in a user-defined manner. The user of computing device 100 may interface with display 128 (e.g., via user interface 122) to configure the manner in which the images are generated (e.g., with zoom settings applied, with or without flash, focus settings, exposure settings, video or still images, and other parameters). For example, CPU 106 may receive via user interface 122 an instruction to capture images in a low power HDR mode (e.g., capture and generate an HDR image in a low power mode).

ISP 123 may be configured to use at least one of two low power HDR modes described below in conjunction with FIGS. 2-8. In some examples, ISP 123 may be configured to determine which of the low power HDR modes to use, based on a pre-defined criteria (e.g., target image quality), for example. In some examples, IISP 123 may be configured to automatically determine one of two or more low power HDR modes.

In some examples, camera processor(s) 104 may output a flow of frames to memory controller 124 in order for the output frames to be stored as a video file. In some examples, CPU 106, video encoder/decoder 107, and/or camera processor(s) 104 may output an HDR image to be stored as a video file. In some examples, memory controller 124 may generate and/or store the output frames in any suitable video file format. In some examples, video encoder/decoder 107 may encode the output frames prior to CPU 106, video encoder/decoder 107, and/or camera processor(s) 104 causing the output frames to be stored as an encoded video. Encoder/decoder 107 may encode frames of image data using various encoding techniques, including those described in standards defined by MPEG 2, MPEG 4, ITU T H.263, ITU T H.264/MPEG-4, Part 10, Advanced Video Coding (AVC), ITU T H.265/High Efficiency Video Coding (HEVC), Versatile Video Coding (VCC), etc., and extensions thereof. In a non-limiting example, CPU 106, video encoder/decoder 107, and/or camera processor(s) 104 may cause the output frames to be stored using a Moving Picture Experts Group (MPEG) video file format.

Display 128 may include a monitor, a television, a projection device, an HDR display, a liquid crystal display (LCD), a plasma display panel, a light emitting diode (LED) array, an organic LED (OLED), electronic paper, a surface conduction electron emitted display (SED), a laser television display, a nanocrystal display or another type of display unit. Display 128 may be integrated within computing device 100. For instance, display 128 may be a screen of a mobile telephone handset, a tablet computer, or a laptop. Alternatively, display 128 may be a standalone device coupled to computing device 100 via a wired or wireless communications link. For instance, display 128 may be a computer monitor or flat panel display connected to a personal computer via a cable or wireless link. Display 128 may provide preview frames that a user may view to see what is being stored or what a picture might look like if camera 102 were to actually take a picture or start recording video.

Some example low power HDR modes employ downscaling by a factor of 2 on a short exposure image for HDR blending. Such low power HDR mode raises concerns about loss of highlight details and potential image quality degradation. Short exposures that are downscaled may capture less detail in highlights. Reduced highlight information may lead to visible artifacts or a decrease in perceived image quality.

Low power modes often involve trade-offs. Reducing power consumption typically comes at the expense of some aspect of performance, in this case, image quality. The techniques of this disclosure provide alternative image data reduction modes that may be executed by ISP 123.

In a first low power HDR mode, ISP 123 may use a single image (for example, a long exposure image) and a “delta” image containing the difference between the short exposure image and the long exposure image. The first low power HDR mode may significantly reduce data compared to using full images or both long and short exposures. The first mode may simplify image processing pipeline (shown in FIG. 2). The first low power HDR mode may be suitable for specific use cases where highlight detail is less important. This first low power HDR mode may use delta generation and reconstruction during image processing.

An alternative low power HDR mode (referred to hereinafter as a second low power HDR mode) involves identifying and discarding pixels that do not significantly contribute to HDR image reconstruction using masking techniques. According to techniques of the present disclosure, ISP 123 operating in the second low power HDR mode may adaptively reduce data in one or more of a long exposure image and/or a short exposure image based on image content, potentially preserving important details while discarding less important information. The second low power HDR mode may be especially effective for scenes with large areas of uniform color or lower dynamic range.

FIG. 2 is a conceptual diagram illustrating image processing pipeline involving HDR image generation using first low power HDR mode according to the techniques of this disclosure.

In one example low power HDR mode inline ISP block 202 outputs both long exposure and a downscaled short exposure images captures by image sensors 112. Long exposure generally captures more detail in shadows and darker areas, even if bright highlights might overexpose. Short exposure may prevent overexposure in highlights, but shadows might lack detail.

According to the techniques of the present disclosure, when ISP 123 operates in a first low power HDR mode shown in FIG. 2, inline ISP block 202 may output only the combination of the long exposure image 204 and the delta image 208. As used herein, the delta image 208 refers to the difference between the long exposure image 204 and the short exposure image 206. ISP 123 may subtract the long exposure from the short exposure to generate the delta image 208, which may isolate the high-brightness details present in the short exposure image 204. In this way, ISP 123 operating in the first low power HDR mode may reduce the full short exposure image 206, where the reduced image has fewer pixels, potentially reducing storage, bandwidth and power requirements.

In some examples, ISP 123 may apply ERC (Exposure Range Correction) gain 210 to the short exposure image 206 before subtraction 212, which may help to enhance the importance of high brightness details in the delta image 208. Adding ERC gain 210 may help compression performed by ISP 123 by focusing on encoding the important details more efficiently. The exposure range is the difference between the brightest and darkest exposures in images. The ERC gain 210 is a factor that is applied by the ISP 123 to adjust the exposure of the short exposure image 206 so that it aligns better with the long exposure image 204 before they are subtracted to create the HDR image using HDR multi-exposure image blending block 214. By adding the ERC gain 210 to the image with the lower exposure before subtraction, ISP 123 essentially amplifies the signal of the short exposure image 206, making the difference between the two images larger. Such larger difference allows ISP 123 to perform more efficient encoding during compression, as the compressed data represents a wider range of values.

For the ISP 123 operating in the low power HDR mode shown in FIG. 2, data processing and storage requirements may be reduced due to omitting portions of the short exposure image 206, and using the delta image 208 instead. The disclosed techniques may also provide improved compression efficiency.

As shown in FIG. 2, image sensor(s) 112 may capture two different images with different exposure times-image 204 with longer exposure for better low-light performance and image 206 with shorter exposure to preserve highlights in bright areas. ISP 123 may apply ERC gain 220 to high-brightness regions of the short exposure image 206.

Specifically, ISP 123 may apply ERC gain 210 to enhance the importance of high-brightness details before performing the difference calculation 212 between the long exposure 204 and short exposure 206 images. Inline ISP block 202 may be configured to combine the information from the long exposure image 204 and delta image 208 by HDR multi-exposure image blending block 214. In an aspect, inline ISP block 202 may optionally perform encoding steps using, for example, memory compression for efficient data representation. In one non-limiting example, inline ISP block 202 may employ Row Column Statistics (RCS) and Universal Bandwidth Compression (UBWC) techniques. RCS technique analyzes data within rows and columns, identifying patterns and redundancies. By encoding RCS statistics instead of raw data, ISP 123 can achieve significant compression. UBWC is a lossless compression technique for storing data in memory. UBWC may use various methods like spatial prediction, palette compression, and run-length encoding to reduce data size. Combining RCS and UBWC can be an effective way to represent data efficiently, especially for large datasets like textures or HDR images. RCS identifies patterns within the data, and UBWC leverages these patterns for further compression.

In an aspect, if inline ISP block 202 performed memory compression, offline ISP 216 may perform decoding steps using UBWC, for example.

In aspect, ISP 123 may perform one or more anchor image processing steps 218, such as, but not limited to, image scaling, inverse gamma processing and the like. The term “anchor image processing,” as used herein, refers to a specific set of techniques used in object detection algorithms, particularly those that utilize anchor boxes. Anchor boxes are predefined shapes (usually rectangles) placed at various locations on an image. The object detection model then refines these anchor boxes to predict the size and location of actual objects in the image. Images may come in various sizes, but object detection models typically require a fixed input size. Image scaling may resize the input image to a specific size. Images captured by cameras are often stored in a format with a non-linear response to light intensity. Gamma correction may apply an inverse gamma function to adjust the image for a more linear relationship between pixel values and actual light intensity. While these techniques are commonly used in anchor image processing 218, the specific processing steps and their order may vary depending on the chosen object detection model and the corresponding training process.

In an aspect, ISP 123 may also perform one or more non-anchor image processing steps 220, such as, but not limited to, image alignment/warping, image scaling, inverse gamma processing, and the like. The term “non-anchor processing,” as used herein, refers to image processing techniques applied in computer vision tasks that do not necessarily involve anchor boxes for object detection. Such techniques may be used for general image pre-processing, image registration, or specific downstream tasks like image classification. Image alignment/warping techniques aim to correct geometric distortions in an image. Such distortions may arise from camera lens imperfections, perspective effects, or object rotations. Similar to anchor image processing 118, scaling may resize the image to a desired size. However, in non-anchor image processing steps 220, the focus may not be on a fixed size for the model but rather on achieving a specific outcome. Same as in anchor image processing steps 218, inverse gamma processing technique may linearize the relationship between pixel values and light intensity. Once again, the specific non-anchor image processing steps 220 and their order may vary in different implementations.

As shown in FIG. 2, ISP 123 may generate the final HDR image using HDR multi-exposure image blending block 214 to blend the long exposure image 204 and the reconstructed short exposure image. In an aspect, HDR multi-exposure image blending block 214 may use motion-adaptive blending. By prioritizing the short exposure in motion areas, ghosting artifacts caused by object movement in the long exposure may be significantly reduced by HDR multi-exposure image blending block 214.

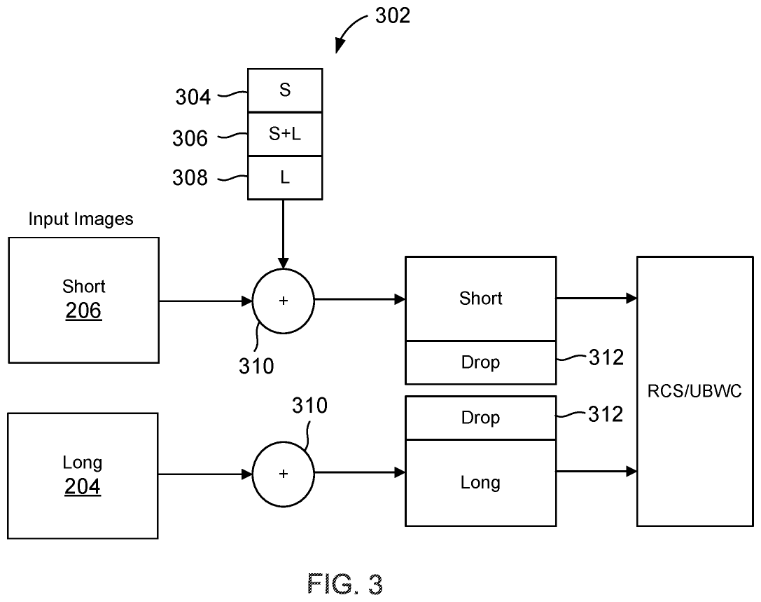

FIG. 3 is a conceptual diagram illustrating example techniques for performing an alternative low power HDR mode according to the techniques of this disclosure. According to the techniques of the present disclosure, when ISP 123 operates in the second low power HDR mode shown in FIG. 3, the ISP 123 may use a mask to identify different regions in the image based on specific characteristics, such as, but not limited to, short exposure areas, low-light areas, short local motion areas, and long exposure highlight pixels.

ISP 123 may apply different levels of data reduction to each region based on their importance for image quality using a masking process relative to some predefined threshold levels. For example, ISP 123 may use more compression in areas less critical for quality, such as, but not limited to, short exposure and low-light areas. ISP 123 may use more data reduction in these areas to reduce data significantly without incurring excessive quality loss. ISP 123 may apply less data reduction in areas with important details, such as, but not limited to, short local motion areas.

Efficient data reduction performed by ISP 123 may lead to lower storage and transmission requirements. Applying different data reduction levels based on image content can offer better data reduction compared to uniform data reduction. By focusing data reduction on less critical areas, ISP 123 may preserve important details, especially in motion and highlight regions.

As shown in FIG. 3, ISP 123 may leverage the previously generated Blending Map (BM), referred to as blending hints, as the mask 302 itself. In an aspect, a blending map may be a grayscale image, where the luma value of each pixel determines the contribution of the corresponding pixel in each bracketed image, used by HDR multi-exposure image blending block 214.

In the example where ISP 123 uses BM as the mask 302, the BM may include at least information about HW (Highlight Weights) and MW (Motion Weights) for each of the plurality of pixels. The HW may indicate the importance of highlight pixels for HDR reconstruction. HDR images aim to represent a wider range of brightness than a single image can capture. Highlights, representing the brightest areas of a scene, are important for achieving this wider dynamic range. Accurate reconstruction of highlights may be helpful for preserving detail and avoiding clipping (losing information due to exceeding sensor capacity). The MW may highlight areas with local motion that need detail preservation. Further, ISP 123 may refine the current mask BM(t) based on the previous mask BM(t−1). In other words, ISP 123 may perform temporal filtering or accumulation of information across frames.

In an aspect, ISP 123 may directly generate the mask using statistics from a “3A BG” source, where 3A refers to Auto White Balance, Auto Focus, and Auto Exposure and BG to background statistics.

As shown in FIG. 3, ISP 123 may receive two input images: short exposure image 206 and long exposure image 204. Short exposure mage 206 may be an image captured by image sensor 112 with a shorter exposure time, preserving highlight details but potentially low detail in low-light areas. Long exposure image 204 may be an image captured by image sensor 112 with a longer exposure time, offering better low-light performance but with potentially clipped highlights in brighter areas.

Blending hints may represent different blending weight maps or flags guiding the inline ISP block 202 on how to combine the short exposure image 206 and the long exposure image 204 for each pixel, where some pixels may be removed or masked. Blending hint “S” 304 may indicate using only the short exposure image 206 information. Blending hint “S+L” 306 may suggest combining information from both short exposure image 206 and long exposure image 204. Blending hint “L” 308 may imply using only the long exposure image information. As shown in FIG. 3, ISP 123 may apply 310 a mask to the short exposure image 206 and long exposure image 204. As a result, ISP 123 may discard (drop) 312 masked pixels.

The mask itself may be generated by ISP 123 based on various factors, such as, but not limited to, local motion, low-light areas, or detail importance. Alternatively, the mask may be predefined and/or selected from a plurality of predefined masks. As described above with respect to FIG. 2, inline ISP block 202 may use RCS/UBWC encoding format while processing the images. RCS refers to “Row Column Statistics,” which may identify patterns and redundancies, for example. UBWC stands for “Universal Bandwidth Compression,” which may optimize data representation efficiency.

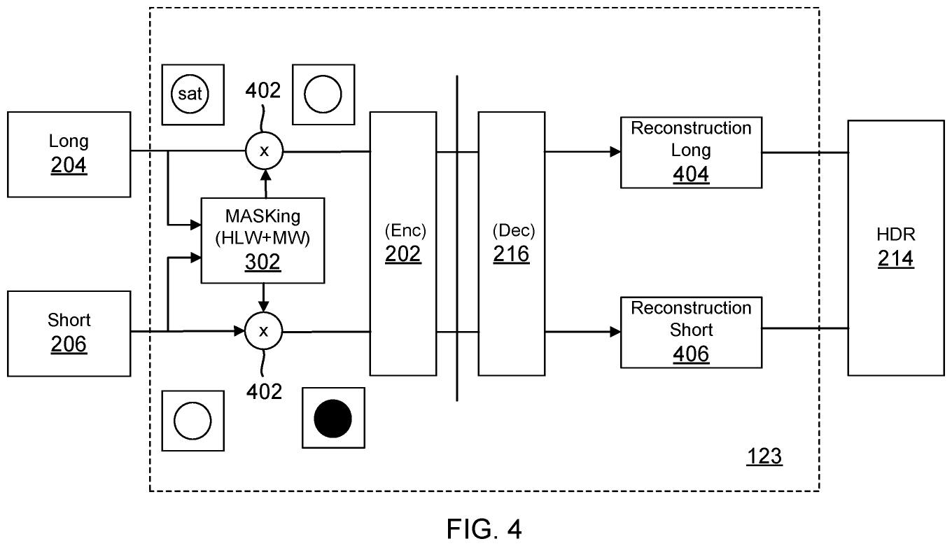

FIG. 4 is a conceptual diagram illustrating image processing pipeline involving HDR image generation using the second low power HDR mode shown in FIG. 3 according to the techniques of this disclosure.

As shown in FIG. 4, inline ISP block 202 may employ a mask strategy to selectively process pixels during HDR blending. In an aspect, inline ISP block 202 may identify and discard pixels deemed unnecessary for optimal HDR reconstruction. Inline ISP block 202 screening out unused pixels may help to improve processing efficiency and potentially data reduction.

ISP 123 may derive the mask used in the image processing pipeline illustrated in FIG. 4 from the blending map, which may be composed of information about motion pixels and highlight saturation areas. As such, pixels with detected motion may be included in the mask to preserve detail. Similarly, areas with high highlight saturation might be included in the mask to ensure accurate HDR representation. The remaining pixels that may be deemed unnecessary for reconstruction may be dropped by ISP 123, based on the mask 302.

Inline ISP block 202 may apply 402 the mask 302 to either the short exposure image 206, long exposure image 204, or both, depending on the information deemed more important for blending. The disclosed masking strategy may only be applied by ISP 123 during the “Full Pass” step. In other words, ISP 123 may exclude masking during specific processing stages that may require all pixels, such as, but not limited to, alignment.

Advantageously, discarding unnecessary pixels may speed up processing, especially for complex HDR algorithms. In the example pipeline shown in FIG. 4, if applied before encoding, masking may decrease data size by focusing on relevant information. Furthermore, in the example of FIG. 4, tailoring the MASK based on image content (motion, highlights) may improve HDR quality by preserving only important details.

In the pipeline shown in FIG. 4, once again, image sensor(s) 112 may capture two different images with different exposure times-image 204 with longer exposure for better low-light performance and image 206 with shorter exposure to preserve highlights.

ISP 123 may generate HLW and MW masks 302. HLW refers to a “Highlight Weight” mask and MW refers to a “Motion Weight” mask.

The highlight weight mask may identify pixels with significant highlight information, based on intensity or saturation levels, for example. The motion weight mask may identify pixels with noticeable motion, using optical flow or temporal difference analysis, for example.

Inline ISP block 202 may perform memory compression, for example, by applying RCS and UBWC during encoding. In other words, inline ISP block 202 may encode images with emphasis on important regions based on mask(s) 302.

The offline ISP block 216 may decode the encoded data. The offline ISP block 216 may apply UBWC during decoding to reconstruct the encoded data accurately. In one or more examples, during the long reconstruction step 404, ISP 123 may process and refine the long exposure image 204 based on the masks and decoded information. The long reconstruction step may include, but is not limited to, image alignment/warping, image scaling, inverse gamma processing, as described above. Similarly, during the short reconstruction step 406, ISP 123 may process and refine the short exposure image 206 based on the masks and decoded information. The short reconstruction step 406 may include anchor image processing such as, but not limited to, image denoising, image scaling, inverse gamma processing, and the like. In the example illustrated in FIG. 4, ISP 123 may generate final HDR image using HDR multi-exposure image blending block 214 by combining the reconstructed images.

In an aspect, ISP 123 may adjust parameters or settings to generate different masks 302, thereby impacting their content and functionality. In one example, ISP 123 may generate two specific types of masks 302-a composition mask and a blending mask.

The composition mask may require only aggregated data from a single frame image. As described above with respect to FIG. 3, the blending mask may need more complex information (one frame image+delta). The ability to control and generate different masks 302 allows the ISP 123 to adapt to various image content or processing needs. The composition mask, requiring only single-frame data, may offer faster generation and potentially lower processing cost. As described above, different masks 302 may target specific content for data reduction, potentially achieving better data reduction while preserving important information.

For generation of the blending mask, ISP 123 may use either the long exposure image 204 or short exposure image 206, depending on specific implementation of an HDR algorithm.

Delta image 208 refers to the difference between long exposure image 204 and short exposure image 206, capturing high-brightness details. For example, the blending mask may be used to refine the blending weights applied to different image regions during HDR reconstruction.

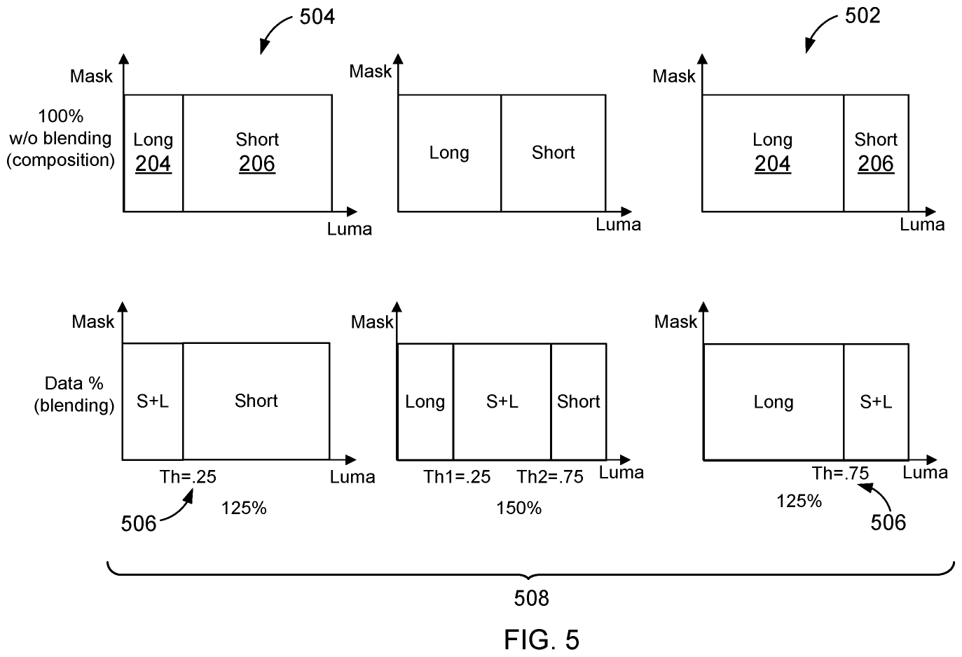

The blending mask may focus on preserving highlight details from the short exposure image 206 while leveraging the low-light performance of the long exposure image 204 in other regions. As described below with respect to FIG. 5, if a blending mask is used, specific areas with important details may receive additional processing or emphasis during blending, based on the blending mask.

Advantageously, in the example of FIG. 4, precise control over blending based on image content may potentially lead ISP 123 to more natural and artifact-free HDR results. Adapting to different image characteristics may ensure important details are not lost during compression or blending.

FIG. 5 is a conceptual diagram illustrating example techniques for performing mask threshold control in the low power HDR mode according to the techniques of this disclosure.

In image processing, mask threshold control refers to adjusting a value that determines which pixels are included or excluded within a mask. As discussed above, ISP 123 may generate one or more masks 302 to exclude less relevant pixels from processing, which may save storage space and computational resources. Focusing on specific image regions may allow ISP 123 to perform tailored processing based on the characteristics of those regions, like preserving details in high-motion areas or enhancing highlights.

The top portion of FIG. 5 illustrates adjustment 508 of threshold value 506 for the composition mask. Setting a high threshold 502 may mean that ISP 123 may only include pixels with significant highlight information from the short exposure image 206, ensuring detail retention. A lower threshold 504 may incorporate more pixels from the short exposure image 206, potentially capturing motion details that may be lost in the long exposure image 204.

Further, the bottom portion of FIG. 5 illustrates adjustment 508 of threshold value 506 for the blending mask. Thus, adjusting 508 the threshold for the blending mask may strike a balance between data reduction and preserving important image features.

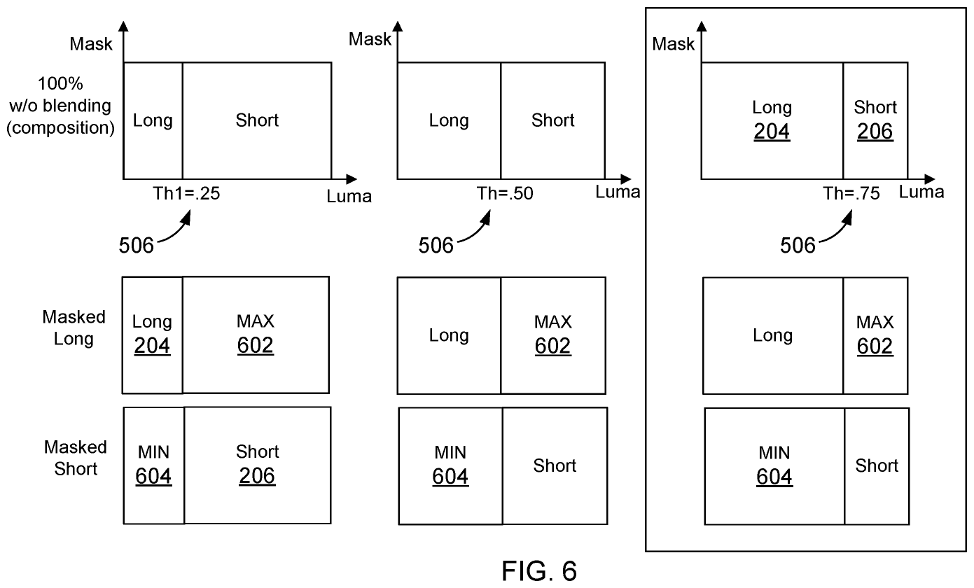

FIG. 6 is a conceptual diagram illustrating example techniques for performing mask threshold control for a composition mask in the low power HDR mode according to the techniques of this disclosure.

The composition mask may be generated by ISP 123 using information from a single frame image (either long exposure image 204 or short exposure image 206). The composition mask may completely control which pixels contribute to the final image, without blending different exposures.

Three different threshold values 506 are illustrated in FIG. 6, which may be used to segment the corresponding image into different regions. For the long exposure image 204, pixels included in the mask for the long exposure image may be replaced with the maximum value 602 between the masked version and the original long exposure image 204. Such replacement may help enhance details in specific regions.

Pixels included in the mask for the short exposure image 206 may be replaced with the minimum value 604 between the masked version and the original short exposure image 206. Such replacement may be used to suppress noise or unwanted artifacts.

Different threshold values 506 allow for customized processing of different image regions based on characteristics of the corresponding image regions. By selectively using the long exposure image 204 in specific regions, important highlight details might be preserved.

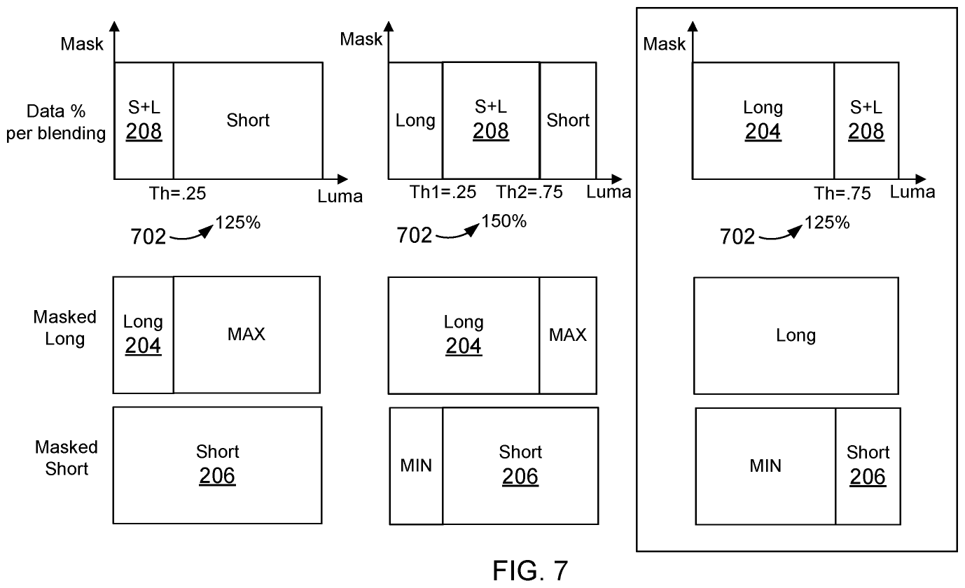

FIG. 7 is a conceptual diagram illustrating example techniques for performing mask threshold control for a blending mask in the low power HDR mode according to the techniques of this disclosure. In the example shown in FIG. 7, the blending mask may utilize information from a single frame image and the delta image 208.

In this case blending of information is involved. In other words, ISP 123 may combine different exposure information using the blending mask.

In the example illustrated in FIG. 7, the blending mask may control the contribution of different exposures based on specific percentage 702 during blending. For example, ISP 123 may perform blending for 125% and 150% of data.

In one non-limiting example, ISP 123 may generate a Highlight Weight (HW) mask and a Motion Weight (MW) mask. To generate the HW mask, ISP 123 may determine if the pixel's luma (brightness) value is greater than a specific threshold. If the luma value is greater than such threshold, ISP 123 may consider that value a highlight and may assign a “MASK_HW” value of 1. If a pixel is not a highlight (MASK_HW!=1), ISP 123 may use the pixel value from the short exposure image 206, because the short exposure image 206 may offer better preservation of details in non-highlight areas. To generate the MW mask, ISP 123 may calculate the average absolute difference (MAD) between the current and a reference image (e.g., the previous frame) for each pixel. The calculated MAD value may serve as a measure of local motion. If the MAD value for a particular pixel exceeds a threshold, indicating significant motion, ISP 123 may assign a “MASK_MW” value of 1. Similar to highlights, ISP 123 may be configured to preserve details in motion areas by using the long exposure image 204 (MASK_MW==1). For pixels without significant motion (MASK_MW!=1) ISP 123 may use the short exposure image value 206. ISP 123 may generate the final MASK by combining the information from both HW and MW masks using a function f (MASK_HW, MASK_MW, anchor). In an aspect, the function f may take into account the relative importance of highlights and motion for each pixel. By using different exposure information based on highlight and motion detection, the disclosed techniques aim to retain important details in various image regions. Focusing on details while potentially discarding less critical information from either exposure leads to more effective data reduction.

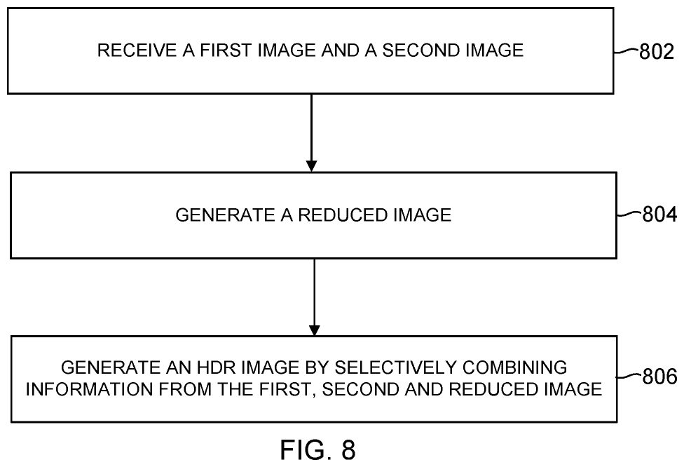

FIG. 8 is a flowchart showing an example method of operation according to the techniques of this disclosure. For ease, the example is described with respect to FIG. 1 and FIGS. 2-7.

As shown in FIG. 8, ISP 123, while operating in a low power HDR mode, may receive a first image having a first exposure time and a second image having a second exposure time (802). In some examples, the first image may be a long exposure image and the second image may be a short exposure image. Short exposure mage 206 may be an image captured by image sensor 112 with a shorter exposure time. Long exposure image 204 may be an image captured by image sensor 112 with a longer exposure time, offering better low-light performance but with potentially clipped highlights.

In some examples, ISP 123 may generate a generate at least one reduced image from the first image or the second image (804). In one example, the reduced image may be delta image 208. Delta image 208 refers to the difference between long exposure image 204 and short exposure image 206, capturing high-brightness details.

In some examples, ISP 123 may generate an HDR image by selectively combining information from at least two of the first image, the second image and the at least one reduced image (806). In some examples, ISP 123 may generate the HDR image by selectively combining information from the long exposure image and the delta image. In some examples, ISP 123 may generate the HDR image by applying a mask to at least one of the long exposure image 204 and short exposure image 206 to generate the reduced image.

The following describes other example aspects of the disclosure. The techniques of the following aspects may be used separately or in any combination.

Clause 1. A computing device for image processing, the computing device comprising: a memory; and one or more processors implemented in circuitry, coupled to the memory, and configured to: while operating in a low power high dynamic range (HDR) mode: receive a first image having a first exposure time and a second image having a second exposure time; generate at least one reduced image from the first image or the second image; and generate an HDR image by selectively combining information from at least two of the first image, the second image and the reduced image.

Clause 2. The computing device of clause 1, wherein the one or more processors configured to generate the at least one reduced image is further configured to: generate a delta image comprising a difference between the first image and the second image, wherein the delta image is the at least one reduced image.

Clause 3. The computing device of clause 1, wherein the one or more processors configured to generate the at least one reduced image is further configured to: apply a mask to the first image to generate a masked first image, wherein the masked first image is the at least one reduced image.

Clause 4. The computing device of clause 1, wherein the one or more processors configured to generate the at least one reduced image is further configured to: apply a mask to the second image to generate a masked second image, wherein the masked second image is the at least one reduced image.

Clause 5. The computing device of clause 1, wherein the one or more processors configured to generate the at least one reduced image is further configured to: apply a mask to the first image to generate a masked first image and apply the mask to the second image to generate a masked second image, wherein the masked first image and the masked second image are the at least one reduced image.

Clause 6. The computing device of clause 2, wherein the first image comprises a long exposure image and the second image comprises a short exposure image.

Clause 7. The computing device of clause 6, wherein the one or more processors are further configured to: apply an ERC (Exposure Range Correction) gain to the short exposure image prior to generating the delta image to amplify a signal of the short exposure image.

Clause 8. The computing device of clause 6, wherein the one or more processors configured to generate the HDR image are further configured to: generate the HDR image by selectively combining information from the long exposure image and the delta image.

Clause 9. The computing device of clause 1, wherein the one or more processors configured to generate the HDR image are further configured to: reconstruct the at least one reduced image to generate a reconstructed image; and generate the HDR image using the reconstructed image.

Clause 10. The computing device of clause 1, wherein the one or more processors are further configured to: generate a blending map comprising a grayscale image having a plurality of pixels, wherein a value of each of the plurality of pixels determines a contribution of the corresponding pixel to the generated HDR image.

Clause 11. The computing device of clause 10, wherein the one or more processors configured to generate the HDR image are further configured to: generate the HDR image by selectively combining information from at least two of the first image, the second image and the delta image using the blending map as a mask.

Clause 12. A method comprising: while operating in a low power high dynamic range (HDR) mode: receiving a first image having a first exposure time and a second image having a second exposure time, wherein the first exposure time is longer than the second exposure time; generating at least one reduced image from the first image or the second image; and generating an HDR image by selectively combining information from at least two of the first image, the second image and the at least one reduced image.

Clause 13. The method of clause 12, wherein generating the at least one reduced image comprises: generating a delta image comprising a difference between the first image and the second image, wherein the delta image is the at least one reduced image.

Clause 14. The method of clause 12, wherein generating the at least one reduced image comprises: applying a mask to the first image to generate a masked first image, wherein the masked first image is the at least one reduced image.

Clause 15. The method of clause 12, wherein generating the at least one reduced image comprises: applying a mask to the second image to generate a masked second image, wherein the masked second image is the at least one reduced image.

Clause 16. The method of clause 12, wherein generating the at least one reduced image comprises: applying a mask to the first image to generate a masked first image and applying the mask to the second image to generate a masked second image, wherein the masked first image and the masked second image are the at least one reduced image.

Clause 17. The method of clause 13, wherein the first image comprises a long exposure image and the second image comprises a short exposure image.

Clause 18. The method of clause 17, further comprising: applying an ERC (Exposure Range Correction) gain to the short exposure image prior to generating the delta image to amplify a signal of the short exposure image.

Clause 19. The method of clause 17, wherein generating the HDR image comprises: generating the HDR image by selectively combining information from the long exposure image and the delta image.

Clause 20. A computer-readable medium storing instructions that, when applied by processing circuitry, causes the processing circuitry to: while operating in a low power high dynamic range (HDR) mode: receive a first image having a first exposure time and a second image having a second exposure time, wherein the first exposure time is longer than the second exposure time; generate at least one reduced image from the first image or the second image; and generate an HDR image by selectively combining information from at least two of the first image, the second image and the at least one reduced image.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A computing device for image processing, the computing device comprising:
a memory; and
one or more processors implemented in circuitry, coupled to the memory, and configured to:
while operating in a low power high dynamic range (HDR) mode:
receive a first image having a first exposure time and a second image having a second exposure time, wherein the first exposure time is longer than the second exposure time;
generate at least one reduced image from the first image or the second image; and
generate an HDR image by selectively combining information from at least two of the first image, the second image and the at least one reduced image.

2. The computing device of claim 1, wherein the one or more processors configured to generate the at least one reduced image is further configured to:
generate a delta image comprising a difference between the first image and the second image, wherein the delta image is the at least one reduced image.

3. The computing device of claim 1, wherein the one or more processors configured to generate the at least one reduced image is further configured to:
apply a mask to the first image to generate a masked first image, wherein the masked first image is the at least one reduced image.

4. The computing device of claim 1, wherein the one or more processors configured to generate the at least one reduced image is further configured to:
apply a mask to the second image to generate a masked second image, wherein the masked second image is the at least one reduced image.

5. The computing device of claim 1, wherein the one or more processors configured to generate the at least one reduced image is further configured to:
apply a mask to the first image to generate a masked first image and apply the mask to the second image to generate a masked second image, wherein the masked first image and the masked second image are the at least one reduced image.

6. The computing device of claim 2, wherein the first image comprises a long exposure image and the second image comprises a short exposure image.

7. The computing device of claim 6, wherein the one or more processors are further configured to:
apply an ERC (Exposure Range Correction) gain to the short exposure image prior to generating the delta image to amplify a signal of the short exposure image.

8. The computing device of claim 6, wherein the one or more processors configured to generate the HDR image are further configured to:
generate the HDR image by selectively combining information from the long exposure image and the delta image.

9. The computing device of claim 1, wherein the one or more processors configured to generate the HDR image are further configured to:
reconstruct the at least one reduced image to generate a reconstructed image; and
generate the HDR image using the reconstructed image.

10. The computing device of claim 1, wherein the one or more processors are further configured to:
generate a blending map comprising a grayscale image having a plurality of pixels, wherein a value of each of the plurality of pixels determines a contribution of the corresponding pixel to the generated HDR image.

11. The computing device of claim 10, wherein the one or more processors configured to generate the HDR image are further configured to:
generate the HDR image by selectively combining information from at least two of the first image, the second image and the delta image using the blending map as a mask.

12. A method comprising:
while operating in a low power high dynamic range (HDR) mode:
receiving a first image having a first exposure time and a second image having a second exposure time, wherein the first exposure time is longer than the second exposure time;
generating at least one reduced image from the first image or the second image; and
generating an HDR image by selectively combining information from at least two of the first image, the second image and the at least one reduced image.

13. The method of claim 12, wherein generating the at least one reduced image comprises:
generating a delta image comprising a difference between the first image and the second image, wherein the delta image is the at least one reduced image.

14. The method of claim 12, wherein generating the at least one reduced image comprises:
applying a mask to the first image to generate a masked first image, wherein the masked first image is the at least one reduced image.

15. The method of claim 12, wherein generating the at least one reduced image comprises:
applying a mask to the second image to generate a masked second image, wherein the masked second image is the at least one reduced image.

16. The method of claim 12, wherein generating the at least one reduced image comprises:
applying a mask to the first image to generate a masked first image and applying the mask to the second image to generate a masked second image, wherein the masked first image and the masked second image are the at least one reduced image.

17. The method of claim 13, wherein the first image comprises a long exposure image and the second image comprises a short exposure image.

18. The method of claim 17, further comprising:
applying an ERC (Exposure Range Correction) gain to the short exposure image prior to generating the delta image to amplify a signal of the short exposure image.

19. The method of claim 17, wherein generating the HDR image comprises:
generating the HDR image by selectively combining information from the long exposure image and the delta image.

20. A computer-readable medium storing instructions that, when applied by processing circuitry, causes the processing circuitry to:
while operating in a low power high dynamic range (HDR) mode:
receive a first image having a first exposure time and a second image having a second exposure time, wherein the first exposure time is longer than the second exposure time;
generate at least one reduced image from the first image or the second image; and
generate an HDR image by selectively combining information from at least two of the first image, the second image and the at least one reduced image.
